(19) United States
(12) Patent Application Publication
(10) Pub. No.: US 2025/0377482 A1
(43) Pub. Date: Dec. 11, 2025

(54) SAMPLING GLOBAL ENSEMBLE MEMBERS FOR OPERATIONAL DOWNSCALING IN FORECASTING WEATHER EVENTS

(71) Applicant: Technosylva, Inc., La Jolla, CA (US)

(72) Inventors: Scott Blair Capps, Jackson, WY (US); Xin Qu, Cypress, CA (US)

(21) Appl. No.: 18/754,054

(22) Filed: Jun. 25, 2024

Related U.S. Application Data
(60) Provisional application No. 63/658,303, filed on Jun. 10, 2024.

(51) Int. Cl. G01W 1/10

(52) U.S. Cl. CPC G01W 1/10

(57) ABSTRACT

A service receives a request to output a tuned weather forecast for a weather event, the request including a selection of a plurality of parameters corresponding to the weather event. The service accesses a plurality of weather models configured to predict a coarse weather forecast and filters the plurality of weather models according to the plurality of parameters to generate a filtered set of weather models. For each weather model of the filtered set of weather models, the service determines an information gain metric. The service samples a subset of the weather models based on the information gain metric, aggregates the sampled subset of the weather models into an ensemble filter, and generates a forecast for the weather event using the ensemble filter.

### TECHNICAL FIELD

Aspects of this disclosure generally relate to the field of forecasting weather events, and more particularly relate to a machine learning approach to intelligently sampling global ensemble members.

### BACKGROUND

Global ensemble forecasts are generated and publicly available for use in predicting weather events. Each ensemble member of a global ensemble forecast is generated from initial conditions, which represent an estimated atmospheric state. The atmospheric state accounts for various parameters, such as temperature, wind, moisture, and so on. The initial conditions are obtained by randomly perturbing the best-known observations any numbers of times (e.g., 30 times) to account for uncertainties in the observations. Forecasts can then be performed based on the global ensemble, rather than just based on a single, deterministic initial condition, resulting in a much more accurate forecast over a given forecast window (e.g., typically a two week window).

The output of a global ensemble forecast, while more accurate than a forecast based solely on a deterministic initial condition, is only a coarse-resolution forecast that requires downscaling in order to fine-tune the forecast so it can be used to accurately assess the impact of a particular weather event. Downscaling is a very computationally expensive operation, and it is computationally impractical to perform downscaling across the entire ensemble for each given weather event that one wants to predict. Therefore, forecasters of a given particular weather event are left with sub-optimal options of a huge computational expense in downscaling the entire ensemble, or only downscaling the deterministic initial condition or a given ensemble member and having an inaccurate forecast with a very low degree of confidence.

### SUMMARY

Systems and methods are disclosed herein that apply machine learning and artificial intelligence techniques to sample a subset of ensemble members that, to the exclusion of the unselected ensemble members, optimize for a high degree of accuracy in forecasting while reducing the computational expense required to perform a forecast. For example, the sampling techniques disclosed herein may result in a selection of 9 filters from an ensemble of 30, which produces a forecast having substantially similar accuracy after downscaling to downscaling performed on the entire ensemble of 30, while resulting in a computational expense that is approximately 70% lower than downscaling the entire ensemble to perform the forecast.

In an embodiment, a service receives a request to output a tuned weather forecast for a weather event, the request including a selection of a plurality of parameters corresponding to the weather event. The service accesses a plurality of weather models configured to predict a coarse weather forecast and filters the plurality of weather models according to the plurality of parameters to generate a filtered set of weather models. For each weather model of the filtered set of weather models, the service determines an information gain metric. The service samples a subset of the weather models based on the information gain metric, aggregates the sampled subset of the weather models into an ensemble filter, and generates a forecast for the weather event using a downscaling of the ensemble filter.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 illustrates one embodiment of a system environment for implementing a weather forecast tool.

FIG. 2 illustrates one embodiment of modules used by the weather analysis tool.

FIG. 3 illustrates an exemplary user interface for selecting parameters in connection with the weather forecast tool, in accordance with an embodiment.

FIG. 4 illustrates exemplary output of a function configured to output a plurality of maps indicating where variability is concentrated based on the selected parameters, in accordance with an embodiment.

FIG. 5 illustrates a subset of the plurality of maps having a variability quality, along with a corresponding strength of variability for each ensemble member.

FIG. 6 illustrates results of the ensemble filter using a reduced set of ensemble members, as compared to results of an ensemble filter using all ensemble members.

FIG. 7 is an exemplary flowchart illustrating a process for obtaining information gain while using reduced ensemble members in an ensemble filter for forecasting weather events, in accordance with an embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Figure (FIG. 1 illustrates one embodiment of a system environment for implementing a weather forecast tool. As depicted in FIG. 1, environment 100 includes client device 110 with application 111 installed thereon, network 120, weather forecast tool 130, and weather models 140. Client device 110 may be any device having a user interface useable to interact with weather forecast tool 130 via application 111. Exemplary client devices may include personal computers, laptops, tablets, smartphones, and so on. While only one client device 110 is depicted, any number of client devices may be used. Multiple client devices may be used at a same time to access and otherwise collaborate on forming a weather forecast.

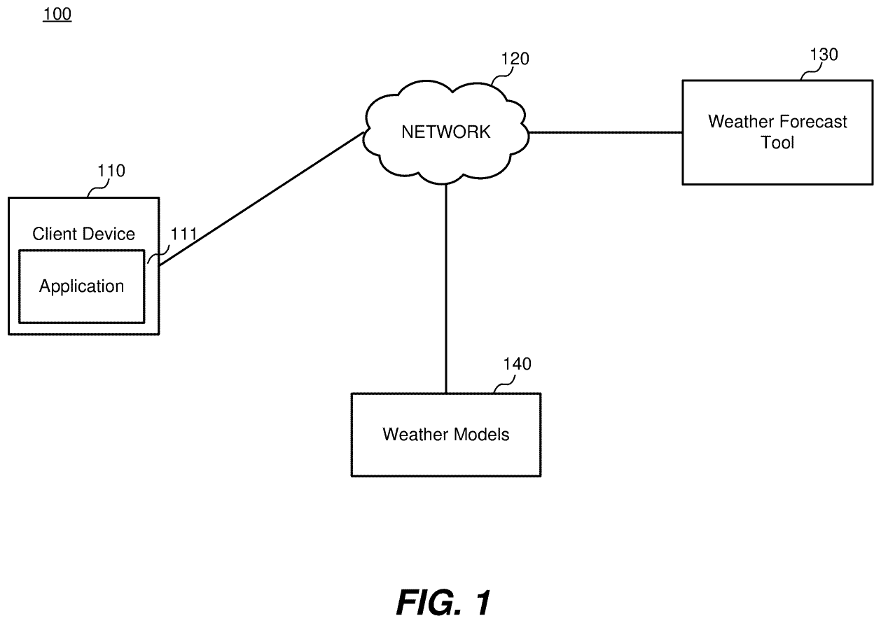

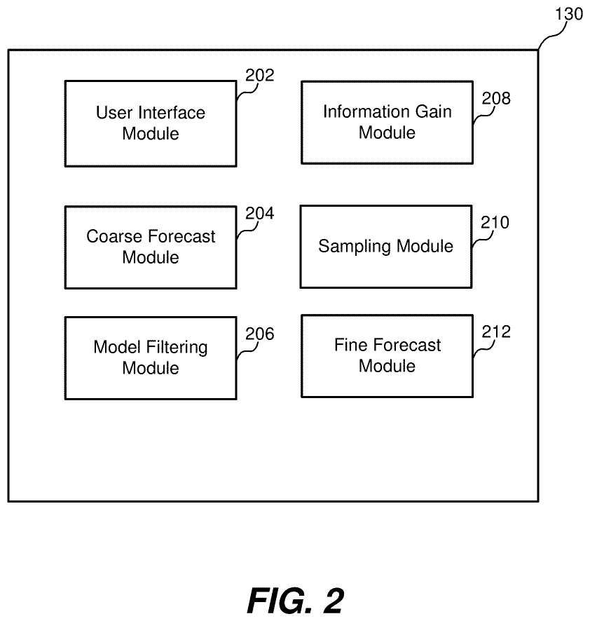

Application 111 may be a dedicated application installed on client device 110 for performing a weather forecast. Application 111 may be installed directly or indirectly from weather forecast tool 130 (e.g., downloaded from form analysis tool 130; downloaded from an application store; from a hard drive having installation code, and so on). Any weather forecast activities may in whole or in part be performed on client device 110 by application 111 or may be performed in the cloud (e.g., using notebook tool 130). Application 111 may be a browser through which weather forecast functionality may be accessed from weather forecast tool 130. Details on activities of client device 110 and application 111 are discussed in further detail with reference to FIGS. 2-7.

Network 120 may be a data communication channel between client device 110 and weather forecast tool 130. The data communication channel may be any channel usable to transmit communications between these entities, such as the Internet, a local area network, a wireless network, a short-range communications network, and so on. Network 120 may facilitate communication between any number of client devices and external servers and services beyond those depicted in environment 100.

Weather forecast tool 130 may be a cloud-based provider that takes various parameters as an input and provides a forecast for a weather event based on those parameters as described herein. All functionality described herein with respect to application 111 may be performed by weather forecast tool 130, and all functionality described herein with respect to weather forecast tool 130 may be performed by application 111. Distributed processing where some activity described is performed by 111 and other activity described is performed by weather forecast tool 130 is implied as within the scope of what is described even where processing is only described with respect to one of the two entities herein. Further details about the functionality of form analysis tool 130 are described below with respect to FIG. 2.

Weather models 140 may be any weather models or information available for public use for forming weather forecasts. Weather models 140 may include local and/or global variables, ensemble members, and so on for forming weather forecasts. These models may form a robust data set based on various sensors collecting data on various weather variables throughout the globe and atmosphere (e.g., weather balloon sensors, satellite data, etc.).

FIG. 2 illustrates one embodiment of modules used by the weather analysis tool. As depicted in FIG. 2, weather forecast tool 130 includes user interface module 202, coarse forecast module 204, model filtering module 206, information gain module 208, sampling module 210, and fine forecast module 212. Fewer or more modules may be used by weather forecast tool 130 than those depicted in order to achieve the functionality disclosed herein. Databases having data referenced by the modules of weather forecast tool 130 may be within or without weather forecast tool 130.

User interface module 202 is used to generate and update a user interface on client devices, thereby enabling users to interact with weather forecast tool 130. User input module 202 may output a user interface having a set of selectable options for requesting a tuned weather forecast for a weather event, and to output information pertaining to that forecast. The term tuned weather forecast, as used herein, may refer to a forecast specific to a given set of parameters. A tuned weather forecast may be contrasted with a coarse weather forecast, which forecasts broad weather patterns measured by any number of possible parameters. The coarse weather forecast provides a broad-scale weather prediction over a large area, such as globally across the earth at any number of altitudes. The tuned weather forecast relies on granular data for a smaller region than the coarse weather forecast relies on (e.g., by downscaling the coarse forecast data, by accessing additional sensor data for the region, accessing terrain and vegetation data, and so on), thereby providing a more accurate forecast for that area than could be provided by the coarse weather forecast.

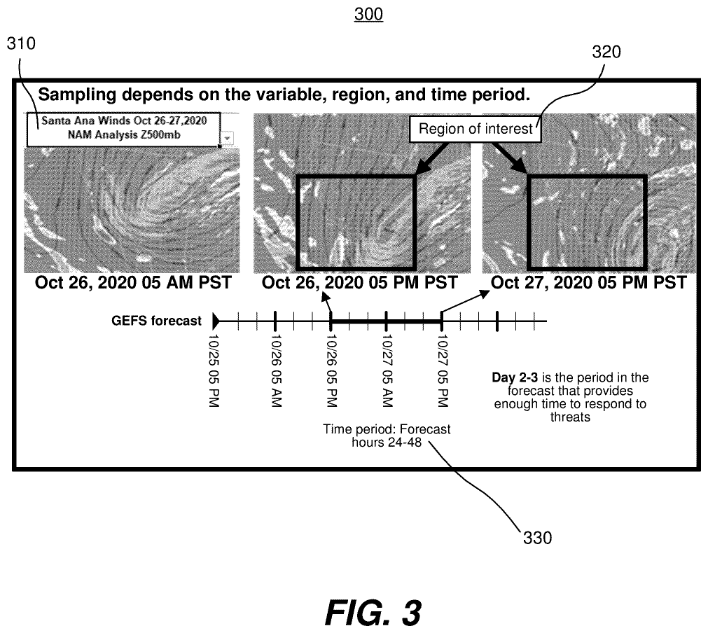

User interface module 202 may output a user interface having selectable options for a user to select any number of parameters corresponding to a weather event. Turning briefly to FIG. 3, FIG. 3 illustrates an exemplary user interface for selecting parameters in connection with the weather forecast tool, in accordance with an embodiment. As depicted in FIG. 3, user interface 300 includes variable option 310, region option 320, and time option 330. These options are merely exemplary, and any number of options may form part of user interface 300. Each of the options included in user interface 300 are selectable and customizable to reflect any of a range of candidate values for their corresponding parameter.

Variable option 310 enables a user to select one or more variables of interest. As depicted in user interface 300, a user has selected the variable to be a pressure coordinate-in this case, an atmospheric height of Z500mb. Any pressure coordinate may be used (e.g., Z850mb), and any other variable of interest may be selected by the user (e.g., precipitation, precipitable water, and so on).

Region option 320 enables a user to select a region. To select a region, a user may drag a rectangle (or draw a non-rectangular region) on a map interface, or may use any other means to define a range of coordinates in scope of a region in which the user is interested in, such as entering coordinates. As depicted, the region is in Southern California, defining a weather event to include a Santa Ana wind event.

Time option 330 enables a user to select a range of times to which the forecast corresponds. The range of times selected in FIG. 3 is a range of times 24-48 hours in the future, but any range of time may be selected. User interface module 202 may receive instructions to select the range of times based on any manner of input, such as an indication of specific times within which to forecast, an indication of times in the future (e.g., forecast for 24-48 hours in the future), and so on.

In some embodiments, user interface 300 accepts a selection of a type of forecast. For example, user input module 202 may receive a selection of “wind event” as a type of forecast, thereby yielding forecast for wind, to the exclusion of forecasting other types of events such as precipitation, fire, lightning, and so on. One or more types may be selected for forecasting within a given weather event forecast.

Returning to FIG. 2, coarse forecast module 204 accesses weather models configured to predict a coarse weather forecast. Coarse forecast module 204 may access these models from weather models 140. The forecast performed by coarse weather models may be extracted from a large region (e.g., Americas) or global region. The models may be, for example, Global Ensemble Forecast System (GEFS) models. The models may, in whole or in part, emanate from a base model with various perturbations resulting in the plurality of models.

Model filtering module 206 may filter the plurality of weather models according to the plurality of parameters to generate a filtered set of weather models. The filtering may be performed by cropping each of the plurality of weather models to portions of those weather models corresponding to the plurality of parameters. For example, a GEFS model may include data for many pressure levels, but a parameter variable may indicate that a user is interested in Z500mb. In such a case, model filtering module 206 may filter to only show data corresponding to that pressure level, obscuring out data for other pressure levels. This may apply to each variable (e.g., a global model has its boundaries reduced to the region of interest; e.g., a GEFS model having forecast data for 5 days may be reduced to data 24-48 hours into the future based on such a time parameter being selected).

Information gain module 208 determines, for each weather model of the filtered set of weather models, an information gain metric. The information gain metric may yield further information for the filtered models (e.g., for the region, weather event, variable, and timeline of interest), which in term enables weather forecast tool 130 to determine, of a pool of candidate filtered models, which models have the largest impact on accurate forecasting, thereby enabling a subset of the filtered models to be used to accurately predict a forecast for the weather event and parameters of interest and saving on processing power.

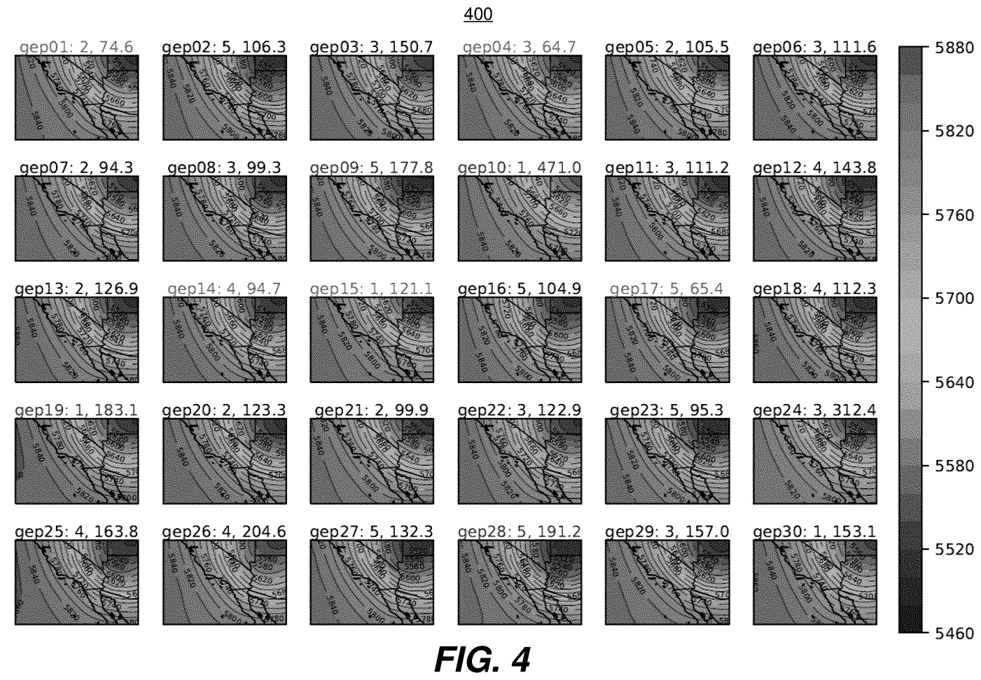

To determine the information gain metric, information gain module 208 may first input the filtered set of weather models into a function configured to output a plurality of maps indicating where variability is concentrated. For example, information gain module 208 may input the filtered set of weather models into an empirical orthogonal function (EOF), and the EOF may output maps indicating where variability is concentrated. The EOF is configured to take in each filtered model (e.g., 30 models), and for the parameters of interest, graphically depict where the filtered models vary the most. Each map output by the EOF shows a “center of action” where the variabilities are strongest. Turning briefly, to FIG. 4, FIG. 4 illustrates exemplary output of a function configured to output a plurality of maps indicating where variability is concentrated based on the selected parameters, in accordance with an embodiment. As depicted in FIG. 4, each map of candidate maps 400 illustrates regions where the filtered models vary the most. For example, if there are 30 models, where is it that those 30 models vary the most over the spatial region of interest.

Information gain module 208 may select a subset of the plurality of candidate maps 400 having a variability quality. The variability quality may be a threshold number of maps (e.g., take the two maps showing a region having the most contribution to variability), a threshold variability contribution (e.g., take all maps having at least a 25% contribution to variability), or any other metric. For example, the two maps showing regions that contribute the most to variability may be selected. The candidate maps 400 may be ranked in a ranked order based on their corresponding measure of variability, thereby enabling a selection of which maps to take based on a ranking.

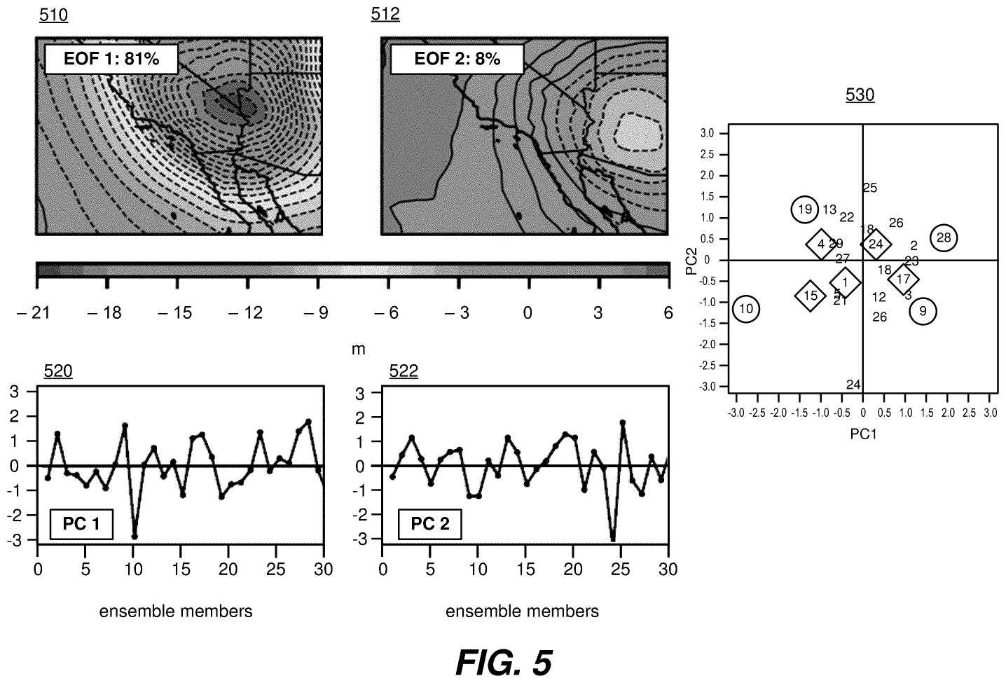

Information gain module may input the subset of the plurality of maps into a model, where the model is configured to output an amplitude of contribution to the variability for each of the plurality of ensemble filters. For example, the model may be a principal component analysis (PCA) model. Turning now to FIG. 5, FIG. 5 illustrates a subset of the plurality of maps having a variability quality, along with a corresponding strength of variability for each ensemble member. As shown in FIG. 5, the subset of candidate maps 400 includes map 510 and map 512. As shown, map 510 explains 81% of the variability between the models, and map 512 explains 8% of the variability between the models. The remaining ones of maps 400 therefore together explain 11% of the variability between the models, and the vast majority of the variability is within just maps 510 and 512 (89% of the variability).

Map 510 is input into a PCA, which outputs principle components 520 showing principle component contribution of each ensemble member to map 510. Map 512 is similarly input into a PCA, which outputs principle components 522. The principle components 520 and 522 show an amplitude of contribution of each ensemble member to the variability of the associated graph. Graph 530 shows each ensemble member mapped to an amplitude grid of each principle component analysis, with principle components 520 as the X axis and principle components 522 as the Y axis. Graph 530 is used to derive the information gain metric, which is indicative of which ensemble members are most representative of the ensemble for generating a forecast.

Sampling module 210 samples a subset of the weather models based on the information gain metric. Sampling module 210 may determine at least some of the subset of the weather models by selecting outliers in graph 530. That is, for each quadrant of graph 530, the ensemble members having a largest distance from the origin point may be defined as the outliers. Therefore, sampling module 210 may select ensemble member 10 from the bottom left quadrant, ensemble member 19 from the top left quadrant, ensemble member 28 from the top right quadrant, and ensemble member 9 from the bottom right quadrant, as the outliers. These outliers collectively capture the ensemble members that contribute the most to the outer boundaries of what might be forecasted. In some embodiments, more than one outlier may be taken from each quadrant (e.g., 2 outliers, 3 outliers, etc.). The numbers in circles in graph 530 are the outliers.

Sampling module may determine additional weather models of the subset using a core set model, such as a self organizing maps (SOM) model, which may be an unsupervised machine learning algorithm. Sampling module 210 may input the filtered maps (filtered based on the parameters) into the SOM model along with instructions to summarize the spatial patterns from the filtered maps into a predefined number of plots that are representative of the span of spatial patterns from all of the filtered maps. For example, the SOM model may take 30 filtered forecasts as input along with instructions to output 5 representative ones of the forecasts. The SOM model may determine the predefined number of plots (e.g., 5 plots), and then may determine which of the forecasts are closest to those plots. Sampling module 210 may then select the ensemble members whose forecasts are closest to those plots as forming a core set. The numbers in diamond boxes in graph 530 are the core set. SOM is an unsupervised method and is similar to a clustering method. The training data is the 30 filtered forecasts depending on regions or parameters of interest. The number of SOMs is predefined, and it is set to 5 in this example. The training process is iterative until the 30 filtered forecasts are organized into 5 groups. Each group has a filtered forecast in the center. Those centers are the core set model.

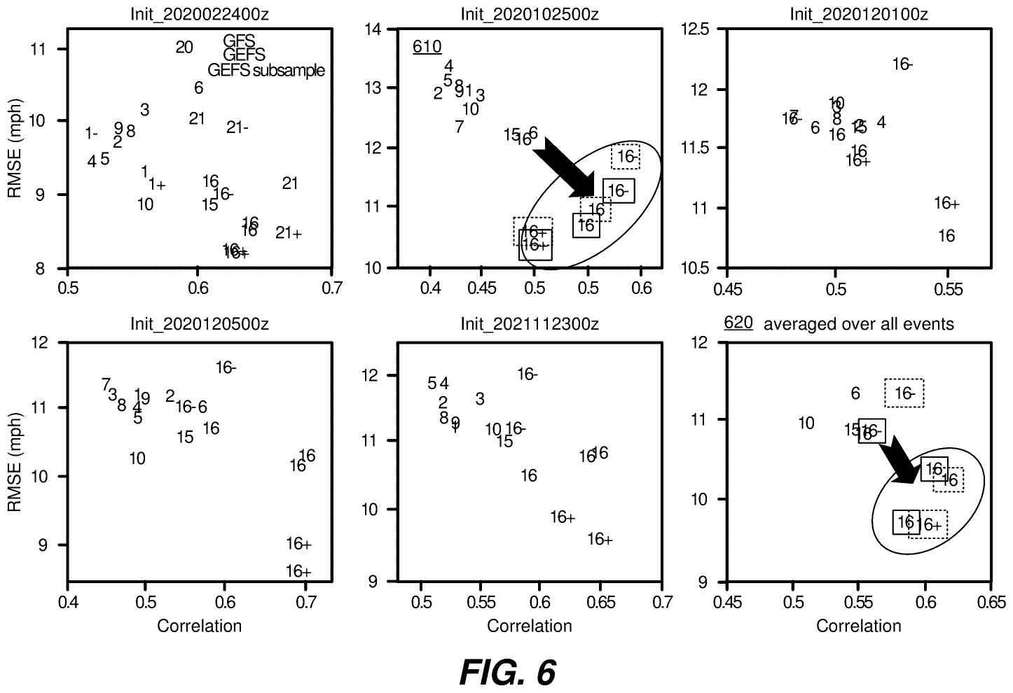

Fine forecast module 212 may aggregate the sampled subset of the weather models into an ensemble filter. That is, the core set and the outlier members may be aggregated into an ensemble filter. Fine forecast module 212 may perform downscaling on the ensemble filter. Fine forecast module 212 may then generate a forecast for the weather event using the downscaled ensemble filter. FIG. 6 illustrates results of the ensemble filter using a reduced set of ensemble members, as compared to results of an ensemble filter using all ensemble members. As depicted in plot 610, the numbers in the top left (e.g., the number 16) show forecasts root mean square error (RMSE) without downscaling, and then in the oval in the bottom right, with downscaling. Downscaling results in a much higher forecast accuracy with a much lower RMSE. Plot 620 shows a plot of correlation against RMSE using downscaling of all ensemble members (bordered in dashed lines), and using just the sampled subset (bordered in solid lines). As can be seen, nearly identical accuracy is achieved using sampling as compared to using all ensemble members, at a computational efficiency savings of nearly 70%.

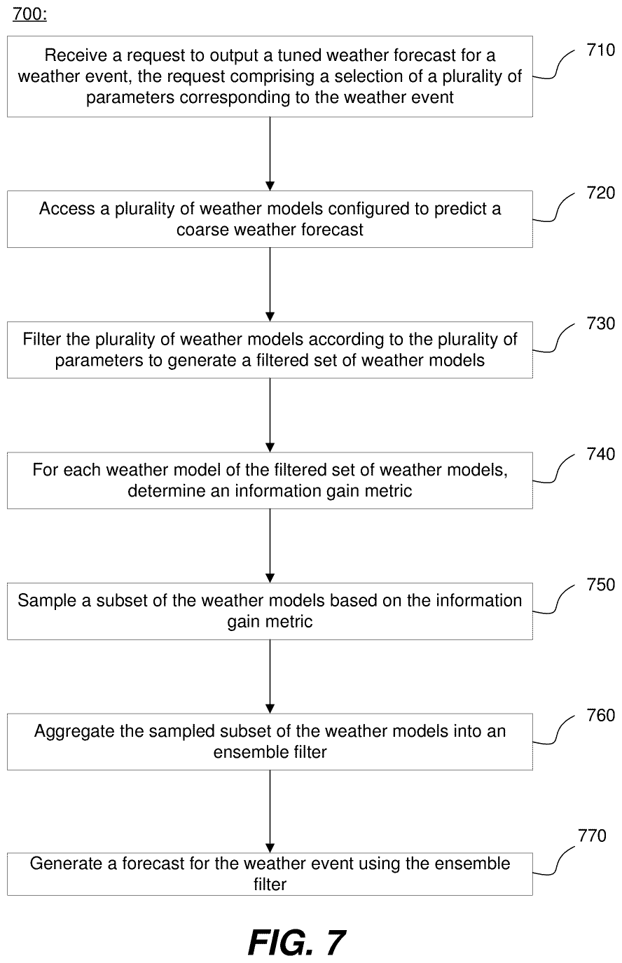

FIG. 7 is an exemplary flowchart illustrating a process for obtaining information gain while using reduced ensemble members in an ensemble filter for forecasting weather events, in accordance with an embodiment. Process 700 may be executed by one or more processors executing instructions stored on a computer-readable medium. The instructions may cause modules of weather forecast tool 130 (e.g., the modules of FIG. 2) to perform operations. Process 700 may begin with weather forecast tool 130 receiving 710 a request to output a tuned weather forecast for a weather event, the request comprising a selection of a plurality of parameters corresponding to the weather event (e.g., using user interface module 202). Weather forecast tool 130 may access 720 a plurality of weather models configured to predict a coarse weather forecast (e.g., using coarse module 204), and may filter 730 the plurality of weather models according to the plurality of parameters to generate a filtered set of weather models (e.g., using model filtering module 206).

Weather forecast tool 130 may, for each weather model of the filtered set of weather models, determine 740 an information gain metric (e.g., using information gain module 208). Weather forecast tool 130 may sample 750 a subset of the weather models based on the information gain metric (e.g., using sampling module 210. Weather forecast tool 130 may aggregate 760 the sampled subset of the weather models into an ensemble filter, and may generate 770 a forecast for the weather event using the ensemble filter (e.g., using fine forecast module 212).

In an example implementation, GEFS models may be sampled to select nine representative embers from stochastically-perturbed 20 or 30 GEFS models reflecting lateral boundary conditions, depending on a given event. For example, there are only 20 GEFs members available for events earlier than 2020, and there are 30+ GEFS models available for more recent events. In this example implementation, to retain the diversity of large-scale flow in GEFS, forecasting of a 500 hPa geopotential height (Z500mb) may be analyzed in the latitude and longitude ranges of 30 N to 46 N, and 130 W to 110 W. These parameters may be identified using user interface 300. To perform this analysis, weather forecast tool 130 may perform a principle component analysis using the mean Z500MB on the second day of the forecast, and may identify four GEFS members with a largest magnitude of the two leading principle components, in the manner described with respect to FIGS. 4-5. Weather forecast tool 130 may also perform a self-organizing map (SOM) analysis based on the mean Z500mb to classify the GEFS boundary conditions into five SOM nodes, and then identify five GEFS members closest to the centroid of each SOM node (e.g., as described with respect to graph 530). Overall, weather forecast tool 130 may select the nine GEFS members as the samples for the ensemble filter that capture both the mean and outlier behavior of the large-scale flow in the full GEFS ensemble. To compare with other configurations, weather forecast tool 130 may analyze the mean, the 25th percentile and the 75th percentile of wind speed, temperature, vapor pressure and vapor pressure deficit based on the WRF output downscaled from the sampled GEFS members.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for sampling to form an ensemble filter through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving a request to output a tuned weather forecast for a weather event, the request comprising a selection of a plurality of parameters corresponding to the weather event;
accessing a plurality of weather models configured to predict a coarse weather forecast;
filtering the plurality of weather models according to the plurality of parameters to generate a filtered set of weather models;
for each weather model of the filtered set of weather models, determining an information gain metric;
sampling a subset of the weather models based on the information gain metric;
aggregating the sampled subset of the weather models into an ensemble filter that is downscaled; and
generating a forecast for the weather event using the ensemble filter.

2. The method of claim 1, wherein the plurality of parameters comprises a variable, a region, and a time range.

3. The method of claim 2, wherein the variable comprises a pressure coordinate.

4. The method of claim 1, wherein filtering the plurality of weather models according to the plurality of parameters to generate the filtered set of weather models comprises cropping each of the plurality of weather models to portions of those weather models corresponding to the plurality of parameters.

5. The method of claim 1, wherein for each weather model of the filtered set of weather models, determining the information gain metric comprises:
inputting the filtered set of weather models into a function configured to output a plurality of maps indicating where variability is concentrated;
selecting a subset of the plurality of maps having a variability quality; and
inputting the subset of the plurality of maps into a model, the model configured to output an amplitude of contribution to the variability for each of the plurality of ensemble filters.

6. The method of claim 5, wherein sampling the subset of the weather models based on the information gain metric comprises weighting the sampling based on the amplitude of contribution to the variability.

7. The method of claim 5, wherein the sampled subset of the weather models comprises one or more of the subset of weather models that are outliers in their amplitude of contribution.

8. The method of claim 5, wherein the function is an empirical orthogonal function configured to output a measure of variability corresponding to each map of the plurality of maps.

9. The method of claim 8, wherein the plurality of maps are ranked into a ranked order based on their corresponding measure of variability, and wherein the variability quality is an amount of maps to be selected from a top of the ranked order.

10. The method of claim 5, wherein the model is a principal component analysis model.

11. A non-transitory computer-readable medium comprising memory with instructions encoded thereon, and one or more processors, that, when executing the instructions, are caused to perform operations, the instructions comprising instructions to:
receive a request to output a tuned weather forecast for a weather event, the request comprising a selection of a plurality of parameters corresponding to the weather event;
access a plurality of weather models configured to predict a coarse weather forecast;
filter the plurality of weather models according to the plurality of parameters to generate a filtered set of weather models;
for each weather model of the filtered set of weather models, determine an information gain metric;
sample a subset of the weather models based on the information gain metric;
aggregate the sampled subset of the weather models into an ensemble filter that is downscaled; and
generate a forecast for the weather event using the ensemble filter.

12. The non-transitory computer-readable medium of claim 11, wherein the plurality of parameters comprises a variable, a region, and a time range.

13. The non-transitory computer-readable medium of claim 12, wherein the variable comprises a pressure coordinate.

14. The non-transitory computer-readable medium of claim 11, wherein the instructions to filter the plurality of weather models according to the plurality of parameters to generate the filtered set of weather models comprise instructions to crop each of the plurality of weather models to portions of those weather models corresponding to the plurality of parameters.

15. The non-transitory computer-readable medium of claim 11, wherein for each weather model of the filtered set of weather models, the instructions to determine the information gain metric comprise instructions to:
input the filtered set of weather models into a function configured to output a plurality of maps indicating where variability is concentrated;
select a subset of the plurality of maps having a variability quality; and
input the subset of the plurality of maps into a model, the model configured to output an amplitude of contribution to the variability for each of the plurality of ensemble filters.

16. The non-transitory computer-readable medium of claim 15, wherein the instructions to sample the subset of the weather models based on the information gain metric comprise instructions to weight the sampling based on the amplitude of contribution to the variability.

17. The non-transitory computer-readable medium of claim 15, wherein the sampled subset of the weather models comprises one or more of the subset of weather models that are outliers in their amplitude of contribution.

18. The non-transitory computer-readable medium of claim 15, wherein the function is an empirical orthogonal function configured to output a measure of variability corresponding to each map of the plurality of maps.

19. The non-transitory computer-readable medium of claim 18, wherein the plurality of maps are ranked into a ranked order based on their corresponding measure of variability, and wherein the variability quality is an amount of maps to be selected from a top of the ranked order.

20. The non-transitory computer-readable medium of claim 15, wherein the model is a principal component analysis model.
